(19) United States
(12) Patent Application Publication
(10) Pub. No.: US 2017/0262291 A1
(43) Pub. Date: Sep. 14, 2017

(54) HETEROGENEOUS COMPUTING SYSTEM WITH A SHARED COMPUTING UNIT AND SEPARATE MEMORY CONTROLS

(71) Applicant: MediaTek Inc., Hsinchu (TW)

(72) Inventors: Shou-Jen Lai, Zhubei (TW); Pei-Kuei Tsung, New Taipei (TW); Sung-Fang Tsai, Hsinchu (TW)

(21) Appl. No.: 15/065,447

(22) Filed: Mar. 9, 2016

(51) Int. Cl. G06F 9/38; G06F 9/30

(52) U.S. Cl. CPC G06F 9/3891; G06F 9/3016; G06F 9/3802; G06F 9/30181

(57) ABSTRACT

A heterogeneous computing system described herein includes a parallel processing module shared among a set of heterogeneous processors. The processors have different processor types, and each processor includes an internal memory unit to store its current context. The parallel processing module includes multiple execution units. A switch module is coupled to the processors and the parallel processing module. The switch module is operative to select, according to a control signal, one of the processors to use the parallel processing module for executing an instruction with multiple data entries in parallel.

### TECHNICAL FIELD

Embodiments of the invention relate to heterogeneous computing.

### BACKGROUND

According to Dennard scaling, voltage and current should be proportional to the linear dimensions of a transistor, and power consumption (the product of voltage and current) should be proportional to the area of a transistor. As the sizes of transistors continue to shrink, the number of transistors that can fit into the same area of a chip has grown exponentially. Thus, it has been predicted that the computing performance per watt can also grow exponentially. However, Dennard scaling appears to have broken down in the last decade. Even though the size of transistors continues to shrink, the per watt computing performance has not improved at the same rate. There are various reasons for the breakdown of Dennard scaling. One of the reasons is that at small sizes current leakage can cause a chip to heat up which increases energy costs and the risk of thermal runaway. To prevent thermal runaway, a portion of the silicon on the chip cannot be powered-on at the nominal operating voltage for a given thermal design power (TDP) constraint. This phenomenon, referred to as “dark silicon,” significantly constraints the per watt computing performance in modern processors.

The breakdown of Dennard scaling has prompted chip manufacturers to resort to multicore processor designs. However, even multicore processors have encountered the same “dark silicon” problem. Depending on the processor architecture, cooling technology, and application workloads, the amount of dark silicon may exceed 50%. Thus, there is a need to improve energy and computing efficiency in modern computer systems.

### SUMMARY

In one embodiment, a heterogeneous computing system is provided. The heterogeneous computing system includes a plurality of processors of different processor types, wherein each processor includes an internal memory unit to store its current context. The heterogeneous computing system also includes a parallel processing module which further includes a plurality of execution units. The heterogeneous computing system also includes a switch module coupled to the processors and the parallel processing module. The switch module is operative to select, according to a control signal, one of the processors to use the parallel processing module for executing an instruction with multiple data entries in parallel.

In another embodiment, a method is provided to be performed by a heterogeneous computing system. The method comprises selecting, according to a control signal, one of a plurality of processors to connect to a parallel processing module in the heterogeneous computing system. The processors have different processor types and each processor includes an internal memory unit to store its context. The parallel processing module includes a plurality of execution units. The method further comprises receiving, by the parallel processing module, an instruction with multiple data entries from the one of the processors; and executing, by the execution units, the instruction on the multiple data entries in parallel.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates an architecture of a heterogeneous computing system according to one embodiment.

FIG. 2 illustrates processors of different processor types in a heterogeneous computing system according to one embodiment.

FIG. 3 illustrates an example of a unified decoder according to one embodiment.

FIG. 4 is a flow diagram illustrating a processor switching process according to one embodiment.

FIG. 5 illustrates an example of a context switch controller according to one embodiment.

FIG. 6 is a flow diagram illustrating a method performed by a heterogeneous computing system according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

A heterogeneous computing system includes more than one type of processors working in tandem to perform computing tasks. For example, a heterogeneous computing system may include processors such as one or more central processing units (CPUs), one or more graphics processing units (GPUs), one or more digital signal processors (DSPs), one or more application-specific instruction set processors (ASIPs), one or more application-specific integrated circuits (ASICs) etc. In some embodiments, the processors may all be integrated into a system-on-a-chip (SoC) platform.

As an example, a heterogeneous computing system may include a combination of CPUs, GPUs, DSPs, ASIPs and ASICs. The CPU performs general-purpose computing tasks. The DSP and ASIP perform signal, image and/or multimedia processing operations. Both DSP and ASIP may be programmable. An example of an ASIP is a specialized hardware accelerator that performs specialized functions supported by the system. An ASIC is a fixed-function processor that performs a pre-determined sequence of specialized operations; e.g., encoding and decoding. The GPU performs graphics processing tasks; e.g., creating 2D raster representations of 3D scenes. These graphics processing tasks are referred to as 3D graphics pipelining or rendering pipelining. The 3D graphics pipelining may be implemented by a combination of fixed-function hardware tailored for speeding up the computation, and general-purpose programmable hardware to allow flexibility in graphics rendering. The general-purpose programmable hardware is also referred to as shader hardware. In addition to rendering graphics, the shader hardware can also perform general computing tasks.

The processors in a heterogeneous computing system typically include parallel execution hardware for performing single-instruction-multiple-data (SIMD) operations. In prior art systems such SIMD architecture is implemented separately in each processor. Therefore, in these systems the SIMD architecture is duplicated. The areas occupied by the duplicated SIMD architecture are not fully utilized because not all processors are performing SIMD execution at the same time.

According to embodiments of the invention, processors of a heterogeneous computing system perform SIMD operations using a shared parallel processing module that includes multiple execution units, such as Arithmetic Logic Units (ALUs). The sharing of the execution units reduces hardware costs and increases hardware utilization. To reduce the context switch overhead when SIMD execution switches from one processor to another, each processor maintains separate memory control. More specifically, each processor maintains its own context in its internal memory unit such as registers and/or buffers. Each processor also has its own memory interface for accessing instructions and data from a system memory such as dynamic random access memory (DRAM) devices. The separate memory control reduces the amount of context switch and therefore increases energy and computing efficiency.

The term “context switch” in computing generally refers to the mechanism of storing and restoring the state (also referred to as “context”) of a process or thread so that execution can be resumed from the same point at a later time. Examples of the context include, but are not limited to program counter, stack pointer, register contents, etc. According to embodiments of the invention, the processors that share the execution units store their respective context (e.g., execution state) locally and separately, such that when SIMD execution switches from a first processor to a second processor, there is no or negligible context switch overhead for storing the context of the first processor and restoring the context of the second processor. That is, instead of using a common process and shared buffers for context switching among processors, each processor stores its own context in its internal memory unit such as local buffers. When the SIMD execution switches from the first processor to the second processor, the context of the first processor remains in the first processor and is ready for use when needed later. The context of the second processor is in the second processor and can be used right away by the second processor. The separate context management avoids the time and energy consuming context storage and restoration when SIMD execution switches among the processors.

Additionally, each processor has its own memory interface for accessing the system memory for instructions, data and other information. The term “memory interface” refers to a hardware unit in the processor that has access to the system memory. Examples of the memory interfaces include, but are not limited to direct memory access (DMA) unit, load and store unit, etc. Having separate memory interfaces enables the processors to keep their specific data flow control.

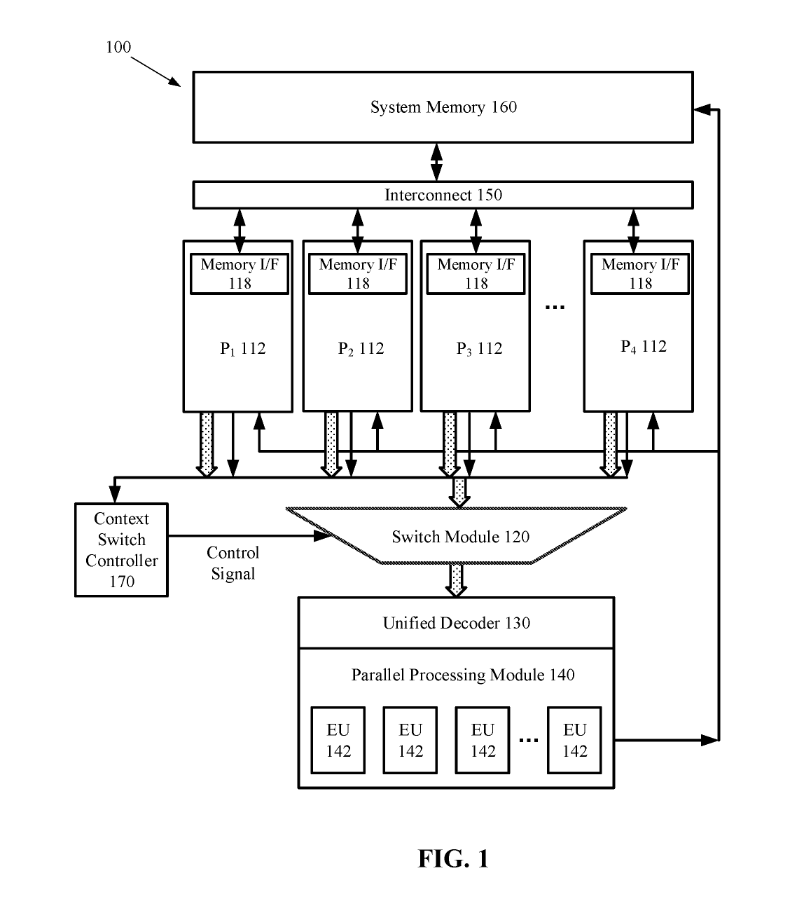

FIG. 1 illustrates an example architecture of a heterogeneous computing system 100 according to one embodiment. The system 100 includes a plurality of processors 112 of different types such as GPUs, DSPs, ASIPs, ASICs, etc., (shown in FIG. 1 as P₁, P₂, . . . P_{N}). In one embodiment, each processor 112 includes a memory interface 118 for accessing a system memory 160 (e.g., a dynamic random-access memory (DRAM) or other volatile or non-volatile random-access memory). Some of the processors may include on-process caches and/or on-processor buffers. Some of the processors 112 may include special functional units different from other processors 112. Some (e.g., at least two) of the processors 112 have different instruction set architectures (ISAs) that define different instructions and/or instruction formats. In one embodiment, each processor 112 may be a programmable processor that executes instructions as defined by its ISA. In another embodiment, the processors 112 may include fixed-function processors, or a combination of programmable processors and fixed-function processors.

The processors 112 are connected to the system memory 160 via an interconnect 150. The processors 112 are also connected to a switch module 120, which is further connected to a unified decoder 130 and a parallel processing module 140. The switch module 120 can be controlled to connect any one of the processors 112 to the unified decoder 130 and the parallel processing module 140. The parallel processing module 140 includes a plurality of execution units (EUs) 142; e.g., ALUs. Each of the execution units 142 executes arithmetic or logic operations, and the parallel processing module 140, as a whole, executes SIMD operations. That is, the parallel processing module 140 can execute a single instruction on multiple data entries in parallel. The instructions executed by the execution units 142 have a unified instruction format according to an instruction set architecture (ISA) defined for the parallel processing module 140. The data executed by the execution units 142 has a unified data format defined in a set of unified data formats. For example, the unified data formats may include full-precision, short integer, floating point, long integer, etc. In one embodiment, the parallel processing module 140 may include a vector execution unit that perform a vector operation on an array of data.

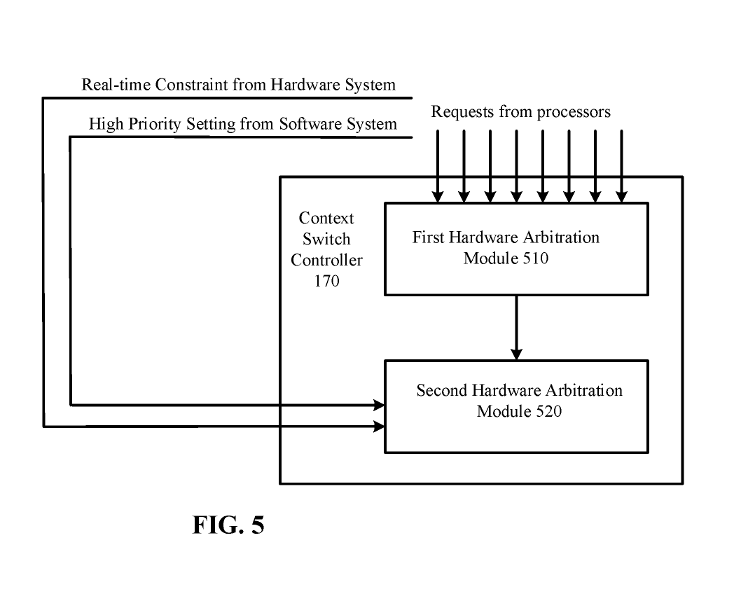

In one embodiment, the switch module 120 is controlled by a context switch controller 170, which may be a hardware unit or a software process located in or executed by one or more CPUs or other control hardware. The context switch controller 170 determines which processor 112 the SIMD execution should be switch to, and generates a control signal that selects a processor 112 to connect to the parallel processing module 140. An example of the context switch controller 170 is provided in FIG. 5. In one embodiment, the processors 112 may send requests, along with priority information if any, to the context switch controller 170 (shown as single-line arrows in FIG. 1) to request for connection. The selected processor 112 can then send an instruction with multiple data entries (shown as arrows with a filled pattern in FIG. 1) to the parallel processing module 140 via the switch module 120 and the unified decoder 130 for execution. In one embodiment, the unified decoder 130 can decode or translate that instruction to the unified instruction format and the accompanying source operands to a unified data format for execution by the parallel processing module 140. That is, the unified decoder 130 can decode or translate instructions of the different ISAs into the ISA of the parallel processing module 140. After an instruction is executed, the execution result is sent to the system memory 160 or the on-processor buffers.

In one embodiment, the heterogeneous computing system 100 may be part of a mobile computing and/or communication device (e.g., a smartphone, a tablet, a laptop, a gaming device, etc.). In one embodiment, the heterogeneous computing system 100 may be part of a desktop computing system, a server computing system, or a cloud computing system.

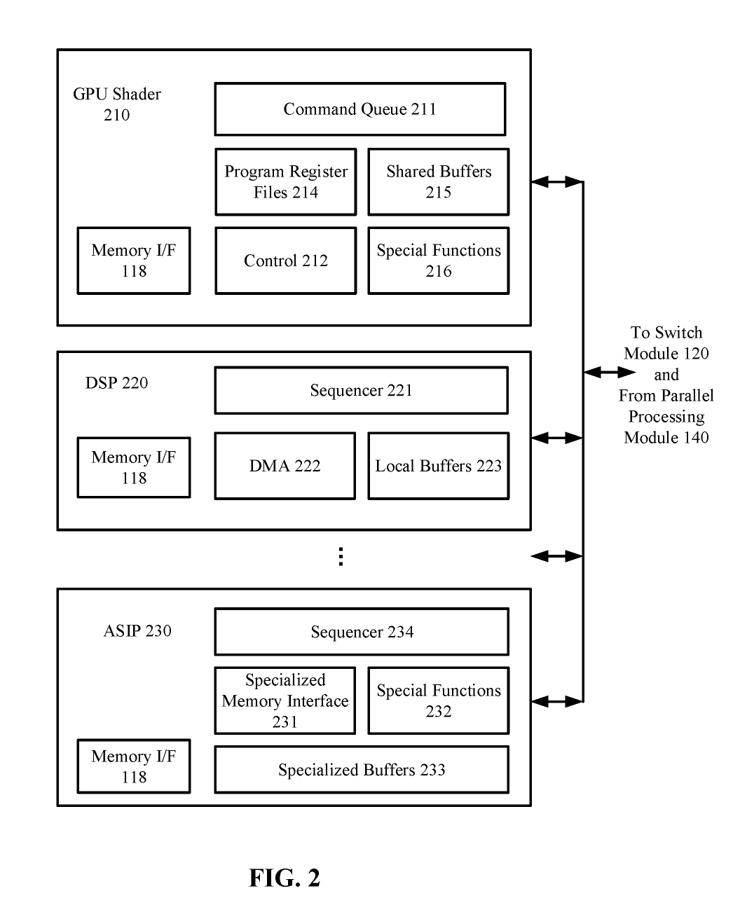

FIG. 2 illustrates an example of the processors 112 of FIG. 1 according to one embodiment. For example, the processors 112 may include a GPU shader 210, a DSP 220 and an ASIP 230. Although three processor types are shown in this example, it is understood that in alternative embodiments there may be more or fewer processor types, and each processor type may have any number of processors. Moreover, it is also understood that the functional features of the GPU shader 210, the DSP 220 and the ASIP 230 as shown have been simplified for the purpose of illustration, in alternative embodiments these processors may include more, fewer and/or different components from what is shown FIG. 2. In the embodiment of FIG. 2, all three processors 112 have different ISAs; in alternative embodiments the processors 112 may have more or fewer (at least two) different ISAs. Moreover, although not shown in the example of FIG. 2, in alternative embodiments as mentioned before the processors 112 may include fixed-function processors such as ASICs for performing a pre-determined sequence of specialized operations. Each of the processors 112 may be selected to send SIMD instructions and data to the parallel processing module 140 for SIMD operations, and may receive the execution results (i.e. intermediate data) from the parallel processing module 140.

The GPU shader 210 is a programmable processor specialized for graphics operation. In one embodiment, the GPU shader 210 includes a command queue 211, a control unit 212, program register files 214, shared buffers 215, special functions 216, the memory interface 118 and other units. Examples of the control unit 212 include, but are not limited to, branch predictors, command fetch units, etc. The DSP 220 is a programmable processor, which includes a sequencer 221, a direct-memory-access (DMA) 222, local buffers 223, the memory interface 118 and other units. The ASIP 230 is also a programmable processor, which includes a specialized memory interface 231, specialized buffers 232, special functions 233, a sequencer 234, the memory interface 118 and other units. Additionally, one or more of the GPU shader 210, DSP 220 and ASIP 230 may include a cache for storing recently accessed and/or pre-fetched data retrieved from the system memory 160, and a buffer or other types of temporary memory for storing the intermediate data generated by the parallel processing module 140, among other information. The DSP 220 and the ASIP 230 are programmable processors for performing specialized functions. Examples of their special functions 216 and 233 include, but are not limited to: special mathematical functional units such as sine, cosine and log functions, graphics processing, voice data processing, video processing, and image processing.

In one embodiment, each processor has a built-in mechanism (e.g., the command queue 211, the sequencer 221 and the sequencer 234) for determining which instruction to execute next, as well as internal registers or buffers (i.e., on-processor registers or on-processor buffers) for storing the current context such as program counter, stack pointer, register contents, etc. When SIMD execution switches from a first processor to a second processor, the stored context of the second processor can be quickly (e.g., in one cycle) retrieved from its internal registers or buffers to start the execution process. The context of the first processor is stored in its internal registers or buffers for fast retrieval when the SIMD execution switches back to the first processor.

Although each processor has internal registers or buffers to store its context, in some scenarios the amount of contexts may exceed the capacity of these internal registers or buffers. For example, when a single processor executes multiple tasks and one or more of the tasks have real-time constraints, the processor may switch the contexts among the multiple tasks. To store the contexts of these multiple tasks, processor may use an external buffer (i.e., off-processor buffer or off-chip buffer) to store the contexts if the amount of contexts exceeds its internal context storage capacity.

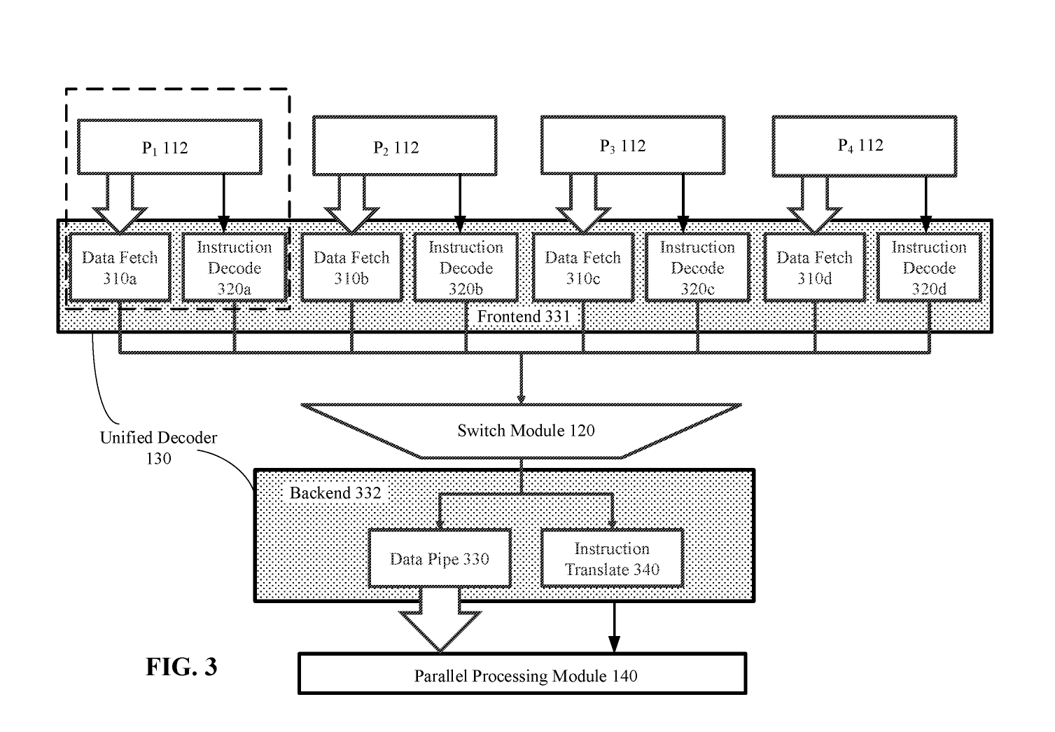

FIG. 3 is a block diagram illustrating one embodiment of the unified decoder 130. In this embodiment, the unified decoder 130 includes a frontend 331 and a backend 332, separated by the switch module 120. The frontend 331 and the backend 332 is upstream and downstream from the switch module 120, respectively. The frontend 331 further includes a data fetch (310a-d) and an instruction decode (320a-d). Using processor P₁ as an example, an instruction fetched by P₁ is decoded by the instruction decode 320a. The instruction decode 320a decodes the instruction according to the ISA of processor P₁. The data fetch 310a fetches the source operands from an on-processor memory (e.g. data cache) according to the decoded instruction. Then the instruction and the fetched data are sent to the backend 332 via the switch module 120 when P₁ is selected for connection to the parallel processing module 140.

In some embodiments, the frontend 331 may be part of one or more of the processors 112; that is, part of the processors' native decode-and-fetch circuitry. For example, processor P₁ may include the instruction decode 320a and the data fetch 310a, as shown in the dashed lines, as part of its native decode-and-fetch circuitry. An instruction is executed by P₁ if it is decoded to be a non-SIMD instruction; the instruction is sent to the parallel processing module 140 for execution if it is decoded to be a SIMD instruction. In some embodiments, one or more processors 112 such as fixed-function processors execute a pre-determined sequence of operation and therefore may not need to decode instructions. These fixed-function processors do not have native decode circuitry for decoding instructions. In this case (e.g., P₄), the unified decoder 130 provides the instruction decode 320d that generates an indicator when a SIMD operation is to be performed. The indicator may specify the SIMD operation to be performed and the data format of the SIMD operation. The indicator and the source operands fetched by the data fetch 310d are then sent to the backend 332 via the switch module 120 when P₄ is selected for connection to the parallel processing module 140.

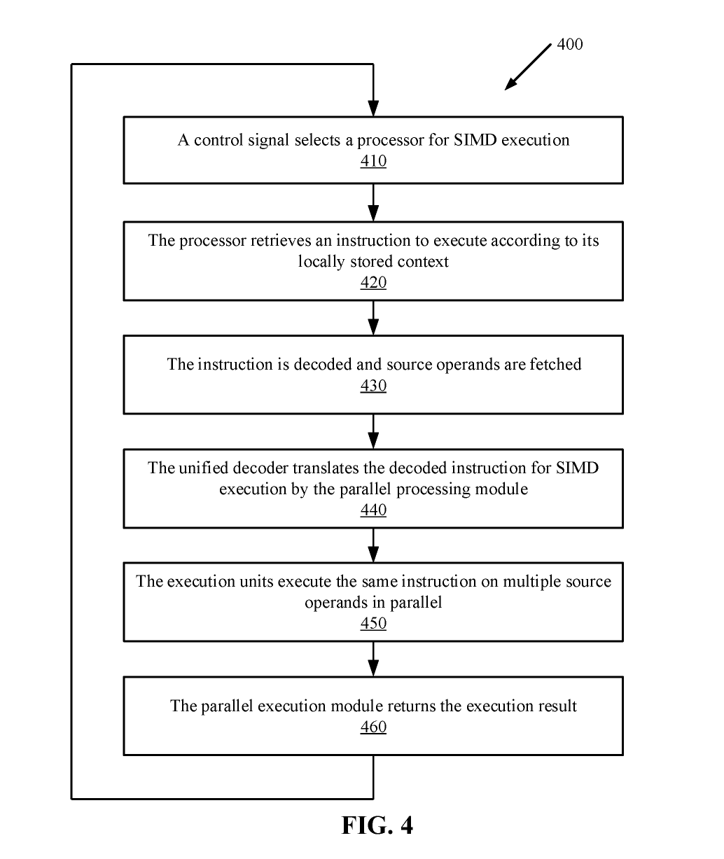

In the embodiment of FIG. 3, the backend 332 of the unified decoder 130 includes a data pipe 330 and an instruction translate 340. The instruction translate 340 may translate the instructions from different processors 112 (e.g., different ISAs) into a unified instruction format executable by the parallel processing module 140. Additionally, the data pipe 330 may modify the data (e.g., source operands) from the processors 112 into a unified data format executable by the parallel processing module 140. For example, if the source operands are in double-precision format and double-precision is not supported by the parallel processing module 140, the data pipe 330 may modify the source operands into floating-point data. A process performed by the components of FIG. 3 will be provided below with reference to FIG. 4.

FIG. 4 is a flow diagram illustrating a processor switching process 400 according to one embodiment. The process 400 may be performed by a heterogeneous computing system, such as the system 100 of FIG. 1. When the control signal selects a processor (“target processor”) to use the parallel processing module 140 for SIMD execution (step 410), the target processor retrieves an instruction to execute according to its locally stored context (step 420). The target processor may retrieve the instruction from its instruction cache or command queue stored locally in the target processor. The instruction is decoded and source operands are fetched (step 430), which are then sent to the unified decoder 130 (e.g., the backend 332 of FIG. 3) via the switching module 120. The unified decoder 130 decodes or translates the instruction into an executable format for the SIMD execution by the parallel processing module 140 (step 440). After receiving the instruction and source operands, the execution units 142 execute the same instruction on the multiple source operands in parallel (step 450). The parallel processing module 140 returns the execution result to the processor 112 (from which the SIMD instruction was sent) or the system memory 160 (step 460).

The process 400 repeats from step 410 each time when a processor is selected for SIMD execution. For example, when the control signal selects another processor (“next processor”) for SIMD execution, the next processor can use its locally stored context to retrieve an instruction for execution without reloading and restoring that context into its local memory. In addition, the context of the previous processor (i.e., the target processor) can stay locally within the target processor. The target processor may continue to perform non-SIMD operations using its locally stored context, or may wait for its turn to use the parallel processing module 140 again for SIMD execution.

FIG. 5 is a diagram illustrating an embodiment of the context switch controller 170 of FIG. 1. In this embodiment, the context switch controller 170 includes a first hardware arbitration module 510 and a second hardware arbitration module 520. In alternative embodiments, the context switch controller 170 may include more, fewer, or different hardware modules from what is shown in FIG. 5. In yet alternative embodiments, some of the hardware modules may be implemented at least partially by software running on a hardware processor.

The context switch controller 170 may use different hardware modules to implement different scheduling policies for requests that have different priorities. For example, in the embodiment of FIG. 5, requests from the processors that do not indicate a priority may be processed by the first hardware arbitration module 510, which schedules the requests according to a predetermined first policy; e.g., a round-robin policy. Requests from the processors that indicate a priority or a real-time constraint may be processed by the second hardware arbitration module 520, which schedules the requests according to a predetermined second policy, e.g., a priority scheduling. That is, requests with a higher priority setting or a tighter real-time constraint are scheduled for connection first. For example, a request with a high priority setting from a software system may be a request from a DSP that runs a voice call software application to handle a voice call. The voice call may be connected to the parallel processing module 140 before a low-priority request from a process such as a background process. As another example, a request with a real-time constraint from a hardware system may be a request from a video decoder. The video decoder may be required to meet a real-time constraint to decode a specified number of frames per second. Such requests with real-time constraints are given a high priority. When a request is processed, the context switch controller 170 sends out a control signal to connect the requesting processor to the parallel processing module 140 via the switch module 120.

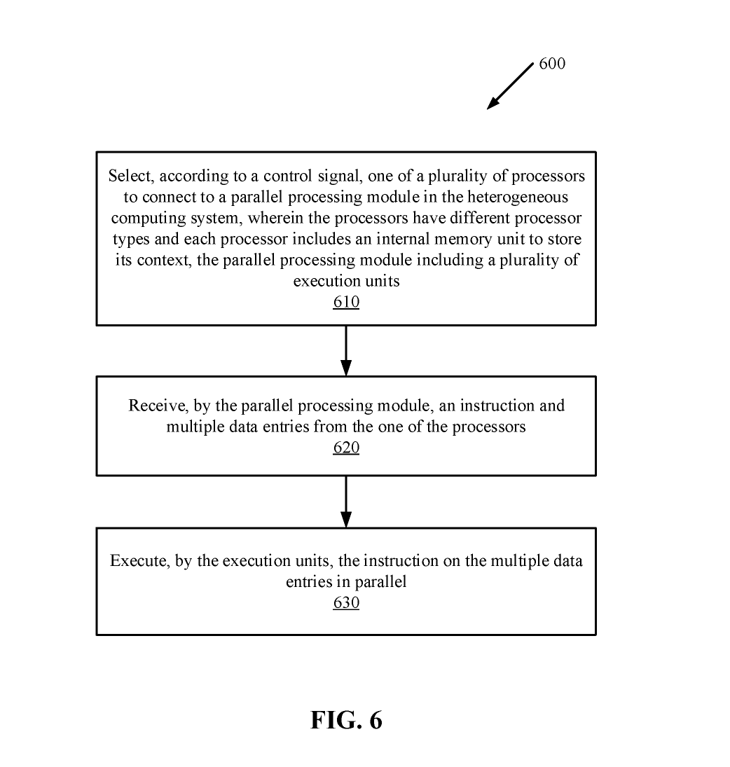

FIG. 6 is a flow diagram illustrating a method 600 performed by a heterogeneous computing system, such as the system 100 of FIG. 1, according to one embodiment. Referring to FIG. 6, the method 600 begins when the system selects, according to a control signal, one of a plurality of processors to connect to a parallel processing module in the heterogeneous computing system (step 610). The processors have different processor types and each processor includes an internal memory unit to store its context. Furthermore, the parallel processing module includes a plurality of execution units. The parallel processing module receives an instruction and multiple data entries from the selected one of the processors (step 620). Then the execution units in the parallel processing module execute the instruction on the multiple data entries in parallel (step 630).

The method 600 may repeat the steps 610-630 whenever the control signal select a different processor for SIMD execution. The context switch among the processors incurs little or no overhead. In one embodiment, the parallel processing module is operative to complete execution for a first processor in a first clock cycle and to receive data from a second processor in a second clock cycle immediate after the first clock cycle.

A heterogeneous computing system with a shared computing unit and separate memory controls has been described. The sharing of the computing unit (e.g., the parallel processing module 140) reduces hardware cost and increases hardware utilization. The separate memory control for each processor enables the processors to maintain their own contexts and data flow controls, and therefore reduces the context switch overhead. Thereby the overall energy and computing efficiency of the system can be improved.

The operations of the flow diagrams of FIGS. 4 and 6 have been described with reference to the exemplary embodiments of FIGS. 1, 3 and 5. However, it should be understood that the operations of the flow diagrams of FIGS. 4 and 6 can be performed by embodiments of the invention other than those discussed with reference to FIGS. 1, 3 and 5, and the embodiments discussed with reference to FIGS. 1, 3 and 5 can perform operations different than those discussed with reference to the flow diagram. While the flow diagrams of FIGS. 4 and 6 shows a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A heterogeneous computing system, comprising:
a plurality of processors of different processor types, wherein each processor includes an internal memory unit to store its current context;
a parallel processing module including a plurality of execution units; and
a switch module coupled to the processors and the parallel processing module, wherein the switch module is operative to select, according to a control signal, one of the processors to use the parallel processing module for executing an instruction with multiple data entries in parallel.

2. The heterogeneous computing system of claim 1, wherein the processors include a combination of programmable processors, at least two of which have different instruction set architectures (ISAs).

3. The heterogeneous computing system of claim 1, wherein the processors include a combination of programmable processors and fixed-function processors.

4. The heterogeneous computing system of claim 1, wherein the processors are operative to retrieve instructions and data from a system memory through respective memory interfaces according to the current context stored in respective internal memory units.

5. The heterogeneous computing system of claim 1, further comprising:
a unified decoder operative to decode instructions of different instruction set architectures (ISAs) into a unified instruction format defined for the parallel processing module, and to modify data of different formats into a unified data format for execution by the parallel processing module.

6. The heterogeneous computing system of claim 5, wherein the unified decoder further comprises a frontend operative to decode the instructions and fetch source operands according to decoded instructions, and a backend operative to translate the instructions into the unified instruction format and modify the source operands into the unified data format.

7. The heterogeneous computing system of claim 1, further comprises a context switch controller operative to receive requests from the processors, schedule the requests according to priorities of the requests, and generate the control signal.

8. The heterogeneous computing system of claim 7, wherein the context switch controller further comprises at least one arbitration hardware module operative to prioritize the requests with a high priority setting or a real-time constraint for connection to the parallel processing module.

9. The heterogeneous computing system of claim 1, wherein the processors include at least a graphical processing unit (GPU).

10. The heterogeneous computing system of claim 1, wherein the parallel processing module is operative to complete execution for a first processor in a first clock cycle and to receive data from a second processor in a second clock cycle immediate after the first clock cycle.

11. A method of a heterogeneous computing system comprising:
selecting, according to a control signal, one of a plurality of processors to connect to a parallel processing module in the heterogeneous computing system, wherein the processors have different processor types and each processor includes an internal memory unit to store its context, and wherein the parallel processing module includes a plurality of execution units;
receiving, by the parallel processing module, an instruction with multiple data entries from the one of the processors; and
executing, by the execution units, the instruction on the multiple data entries in parallel.

12. The method of claim 11, wherein the processors include a combination of programmable processors, at least two of which have different instruction set architectures (ISAs).

13. The method of claim 11, wherein the processors include a combination of programmable processors and fixed-function processors.

14. The method of claim 11, further comprising:
retrieving, by the processors, instructions and data from a system memory through respective memory interfaces according to the current context stored in respective internal memory units.

15. The method of claim 11, further comprising:
decoding, by a unified decoder coupled to the parallel processing module, instructions of different instruction set architectures (ISAs) into a unified instruction format defined for the parallel processing module; and
modifying, by the unified decoder, data of different formats into a unified data format for execution by the parallel processing module.

16. The method of claim 15, wherein the decoding and the modifying further comprises:
fetching, by a frontend of the unified decoder, source operands according to decoded instructions; and
translating, by a backend of the unified decoder, the instructions into the unified instruction format and modify the source operands into the unified data format.

17. The method of claim 11, further comprising:
receiving requests from the processors by a context switch controller;
scheduling, by the context switch controller, the requests according to priorities of the requests; and
generating, by the context switch controller, the control signal.

18. The method of claim 17, wherein scheduling the requests further comprises:
prioritizing the requests with a high priority setting or a real-time constraint for connection to the parallel processing module.

19. The method of claim 11, wherein the processors include at least a graphical processing unit (GPU).

20. The method of claim 11, further comprising:
completing, by the parallel processing module, execution for a first processor in a first clock cycle; and
receiving, by the parallel processing module, data from a second processor in a second clock cycle immediate after the first clock cycle.
